(19) United States
(12) Patent Application Publication
(10) Pub. No.: US 2025/0378164 A1
(43) Pub. Date: Dec. 11, 2025

(54) BINARY MALWARE ATTACK DETECTION

(71) Applicant: INTERNATIONAL BUSINESS MACHINES CORPORATION, ARMONK, NY (US)

(72) Inventors: WARREN WILLIAM GRUNBOK, POUGHKEEPSIE, NY (US); CHRISTOPHER V. DEROBERTIS, HOPEWELL JUNCTION, NY (US); GREGORY PORPORA, FAIRFIELD, CT (US); CANUTE LYNCH, HERNDON, VA (US)

(21) Appl. No.: 18/738,297

(22) Filed: Jun. 10, 2024

(51) Int. Cl. G06F 21/56

(52) U.S. Cl. CPC G06F 21/566; G06F 2221/034

(57) ABSTRACT

Binary malware attack detection according to an example includes processing, by a first set of one or more detectors, run time environment (RTE) code and associated interpretive code to detect special cipher characters and determine a first set of scores. A second set of one or more detectors processes the RTE code and the associated interpretive code to detect malware and determine a second set of scores. It is determined whether one or both of the RTE code and the associated interpretive code are compromised based on the first set of scores and the second set of scores.

### BACKGROUND

The present disclosure relates to methods, apparatus, and products for binary malware attack detection.

### SUMMARY

According to embodiments of the present disclosure, various methods, apparatus and products for binary malware attack detection are described herein. In some aspects, binary malware attack detection includes processing, by a first set of one or more detectors, run time environment (RTE) code and associated interpretive code to detect special cipher characters and determine a first set of scores. A second set of one or more detectors processes the RTE code and the associated interpretive code to detect malware and determine a second set of scores. It is determined whether one or both of the RTE code and the associated interpretive code are compromised based on the first set of scores and the second set of scores.

### BRIEF DESCRIPTION OF THE DRAWINGS

FIG. 1 sets forth an example computing environment according to aspects of the present disclosure.

FIG. 2 sets forth an example malware detection system according to aspects of the present disclosure.

FIG. 3 sets forth a compromised interpretive code detection system according to aspects of the present disclosure.

FIG. 4 sets forth a compromised run time environment detection system according to aspects of the present disclosure.

FIG. 5 sets forth a flow diagram of a method for compromised run time environment detection according to aspects of the present disclosure.

FIG. 6 sets forth a flow diagram of a malware detection method using image analysis according to aspects of the present disclosure.

FIG. 7 sets forth a flow diagram of a malware detection method using frequency analysis according to aspects of the present disclosure.

FIG. 8 sets forth a flow diagram of a method for binary malware attack detection according to aspects of the present disclosure.

### DETAILED DESCRIPTION

Malware is any software intentionally designed to cause damage to a computer, server, client, or computer network. Malware does the damage after it is implanted or introduced in some way into a target's computer and can take the form of executable code, scripts, active content, and other software. The code is described as computer viruses, worms, Trojan horses, ransomware, spyware, adware, and scareware, among other terms. Malware can be inserted from external threats, internal threats, and a compromised supply chain. Malware has a malicious intent, acting against the interest of the computer user.

One form of malware is a binary cyber weapon. From an operational standpoint, a binary cyber weapon includes two core components, the first being compromised run time environment (RTE) code that is specifically designed to detect and operationalize embedded stegomalware code at run time, and the second is the overall run time code. Here, the two components, the run time code (also known as the “Transport” with the active stegomalware component) and the compromised RTE (also known as the “Trigger-Activator”) are inert when separated. A compromised RTE may compile and run non-malicious code as a normal RTE at run time providing no indicators to end users of its malicious capabilities. Likewise, with embedded stegomalware in the run time, if it is compiled and run with a normal RTE, the malware may never be activated. Thus, to have an effective detection and alerting capability, both the RTE and all code are scanned in some examples. In some examples, the RTE is scanned after every version update, and all code is scanned prior to RTE submission.

There can be multiple sources of stegomalware, including intentional as well as unintentional, and in both cases, mating with an unknown compromised RTE could be disastrous. The output of a successful stegomalware attack may have its genesis from a single input or multiple inputs. Unintentional sources of stegomalware may come from opensource libraries/code, GitHub code including code generated and employed via GitHub Copilot code generator, and/or Chat GPT code generation.

Stegomalware may be embedded in comment sections of code obscured with and behind special character sequences and may also be either encrypted and/or encoded with Base64 encoding to further enhance its low observability. If the code is either encrypted and/or encoded, the compromised RTE may decode/decrypt the stegomalware with the provided key as part of the run time. Due to the complexity and nature of such threats, a system for information discovery in a high entropy system would be helpful. By employing multiple analysis techniques and detector systems as disclosed herein, obfuscated or encrypted threats that may have previously avoided detection may be discovered and handled accordingly.

Some examples disclosed herein are directed to a system and method for detection of malicious output from language interpreters. Some examples include a mechanism to predict that a language interpreter has been compromised and is capable of producing unexpected alternative and likely malicious execution paths that may not be able to be detected by current scanning methods. In some examples, a series of code scanners and RTE integrity checks identify possible lock and key scenarios that may produce malicious execution behavior.

Some examples disclosed herein are directed to a method for detecting an embedded binary malware attack in code, which includes processing RTE code and accompanying interpretive code through a first detector to detect special cipher characters in the code. The method includes processing the RTE code and accompanying interpretive code through a second detector to detect native malware in the code. The method includes processing the RTE code and accompanying interpretive code through a third detector (e.g., to perform a form of entropy analysis and/or other methods) to detect encrypted malware in the code. The method includes generating by each detector a characterization of the code and a score for the code. The method includes determining if the RTE code and/or accompanying interpretive code is compromised based upon the characterization of the code and the score for the code.

Some examples disclosed herein are not based upon a single detector but rather an ensemble of detectors for a compromised RTE and/or its accompanying compromised interpretive code (e.g., Java, Python, Perl, etc.) that it could be operating against. Each ensemble of detectors may be focused on different methods of malicious content insertion from (1) detection of special cipher characters; (2) detection of native malware; and (3) detection of encrypted malware. In some examples, these detectors operate passively, and independently characterize and score its specific results, which are aggregated into a Bayesian normalization model to mitigate bias by any one detector. In some examples, a goal is not to detect and characterize a specific malware (e.g., especially one that has been either encoded and/or encrypted) but rather to identify specific patterns, signals and characteristics that are not just anomalous but have strong indicators of malicious content capability warranting additional investigation before proceeding in any development and/or production set of activities.

An example of the present disclosure is directed to a method for binary malware attack detection, which includes processing, by a first set of one or more detectors, RTE code and associated interpretive code to detect special cipher characters and determine a first set of scores. The method includes processing, by a second set of one or more detectors, the RTE code and the associated interpretive code to detect malware and determine a second set of scores. The method includes determining whether one or both of the RTE code and the associated interpretive code are compromised based on the first set of scores and the second set of scores.

Examples of the method include various technical features that yield technical effects that provide various improvements to computer technology. For instance, some examples include the technical features of processing, by a first set of one or more detectors, RTE code and associated interpretive code to detect special cipher characters and determine a first set of scores; processing, by a second set of one or more detectors, the RTE code and the associated interpretive code to detect malware and determine a second set of scores; and determining whether one or both of the RTE code and the associated interpretive code are compromised based on the first set of scores and the second set of scores. These technical features yield the technical effect of providing information discovery in a high entropy system. By employing multiple analysis techniques and detector systems, obfuscated or encrypted threats that may have previously avoided detection may be discovered and handled accordingly. Some examples provide the ability to predict that an RTE has been compromised and is capable of producing unexpected alternative and likely malicious execution paths that may not be able to be detected by current scanning methods. Some examples identify possible lock and key scenarios that may produce malicious execution behavior.

In some examples of the method, the first set of one or more detectors is to determine a first set of characterizations and scores, the second set of one or more detectors is to determine a second set of characterizations and scores, and where determining whether one or both of the RTE code and the associated interpretive code are compromised is based on the first set of characterizations and scores and the second set of characterizations and scores. These technical features yield the technical effect of employing multiple detectors to determine multiple characterizations and scores to facilitate identification of threats that may have previously avoided detection.

In some examples of the method, the second set of one or more detectors is to detect native malware, and the method further includes processing, by a third set of one or more detectors, the RTE code and the associated interpretive code to detect encoded or encrypted malware and determine a third set of scores; and determining whether one or both of the RTE code and the associated interpretive code are compromised based on the first set of scores, the second set of scores, and the third set of scores. These technical features yield the technical effect of employing multiple detectors to determine multiple scores to facilitate identification of obfuscated or encrypted threats that may have previously avoided detection.

In some examples of the method, processing, by the third set of one or more detectors, the RTE code and the associated interpretive code, further includes converting the RTE code and the associated interpretive code to data in one or more spectral formats; and analyzing the data in the one or more spectral formats. These technical features yield the technical effect of using spectral analysis (e.g., across various frequencies of the electromagnetic spectrum) to extract highly obfuscated information in a high entropy environment to facilitate identification of obfuscated or encrypted threats that may have previously avoided detection.

In some examples of the method, the one or more spectral formats includes an acoustic format. These technical features yield the technical effect of using spectral analysis with an acoustic format to uncover subtle, low observable anomalies in code that may be inconsistent with normal environmental attributes and behavior and that may have previously avoided detection including by use of other spectral formats.

In some examples of the method, the one or more spectral formats includes an image format. These technical features yield the technical effect of using spectral analysis with an image format to uncover subtle, low observable anomalies in code that may be inconsistent with normal environmental attributes and behavior and that may have previously avoided detection including by use of other spectral formats.

In some examples of the method, the third set of one or more detectors includes one or more machine learning models trained using known malware. These technical features yield the technical effect of using one or more machine learning models to facilitate the accurate detection of obfuscated or encrypted threats that may have previously avoided detection, and providing the ability to continually adapt to new threats.

Some examples of the method further include generating, in response to determining that one or both of the RTE code and the associated interpretive code are compromised, an alert. These technical features yield the technical effect of generating an alert, which may be sent to a developer, for example, to indicate that code/libraries are potentially compromised, and indicate what was found and where it was found to avoid damage that might result from use of the comprised code.

Another example of the present disclosure is directed to a system for binary malware attack detection, which includes a first set of one or more detectors to process RTE code and associated interpretive code to detect special cipher characters and determine a first set of scores. The system includes a second set of one or more detectors to process the RTE code and the associated interpretive code to detect malware and determine a second set of scores. The system includes a composite detector to determine whether one or both of the RTE code and the associated interpretive code are compromised based on the first set of scores and the second set of scores.

Examples of the system include various technical features that yield technical effects that provide various improvements to computer technology. For instance, some examples include the technical features of a first set of one or more detectors to process RTE code and associated interpretive code to detect special cipher characters and determine a first set of scores; a second set of one or more detectors to process the RTE code and the associated interpretive code to detect malware and determine a second set of scores; and a composite detector to determine whether one or both of the RTE code and the associated interpretive code are compromised based on the first set of scores and the second set of scores. These technical features yield the technical effect of providing information discovery in a high entropy system. By employing multiple analysis techniques and detector systems, obfuscated or encrypted threats that may have previously avoided detection may be discovered and handled accordingly. Some examples provide the ability to predict that an RTE has been compromised and is capable of producing unexpected alternative and likely malicious execution paths that may not be able to be detected by current scanning methods. Some examples identify possible lock and key scenarios that may produce malicious execution behavior.

In some examples of the system, the first set of one or more detectors is to determine a first set of characterizations and scores, the second set of one or more detectors is to determine a second set of characterizations and scores, and the composite detector is to determine whether one or both of the RTE code and the associated interpretive code are compromised based on the first set of characterizations and scores and the second set of characterizations and scores. These technical features yield the technical effect of employing multiple detectors to determine multiple characterizations and scores to facilitate identification of threats that may have previously avoided detection (e.g., through obfuscation techniques).

In some examples of the system, the second set of one or more detectors is to detect native malware, and the system further includes a third set of one or more detectors to process the RTE code and the associated interpretive code to detect encoded or encrypted malware and determine a third set of scores, and where the composite detector is to determine whether one or both of the RTE code and the associated interpretive code are compromised based on the first set of scores, the second set of scores, and the third set of scores. These technical features yield the technical effect of employing multiple detectors to determine multiple scores to facilitate identification of obfuscated or encrypted threats that may have previously avoided detection.

In some examples of the system, the third set of one or more detectors are to convert the RTE code and the associated interpretive code to data in one or more spectral formats, and analyze the data in the one or more spectral formats. These technical features yield the technical effect of using spectral analysis to extract highly obfuscated information in a high entropy environment to facilitate identification of obfuscated or encrypted threats that may have previously avoided detection.

In some examples of the system, the one or more spectral formats includes an acoustic format. These technical features yield the technical effect of using spectral analysis with an acoustic format to uncover subtle, low observable anomalies in code that may be inconsistent with normal environmental attributes and behavior and that may have previously avoided detection including by use of other spectral formats.

In some examples of the system, the one or more spectral formats includes an image format. These technical features yield the technical effect of using spectral analysis with an image format to uncover subtle, low observable anomalies in code that may be inconsistent with normal environmental attributes and behavior and that may have previously avoided detection including by use of other spectral formats.

In some examples of the system, the third set of one or more detectors includes one or more machine learning models trained using known malware. These technical features yield the technical effect of using one or more machine learning models to facilitate the accurate detection of obfuscated or encrypted threats that may have previously avoided detection, and providing the ability to continually adapt to new threats.

Some examples of the system include an alert monitor to generate, in response to determining that one or both of the RTE code and the associated interpretive code are compromised, an alert. These technical features yield the technical effect of generating an alert, which may be sent to a developer, for example, to indicate that code/libraries are potentially compromised, and indicate what was found and where it was found to avoid damage that might result from use of the comprised code.

Another example of the present disclosure is directed to an apparatus for binary malware attack detection, which includes a processing device. The apparatus includes memory operatively coupled to the processing device, where the memory stores computer program instructions that, when executed, cause the processing device to process, by a first set of one or more detectors, RTE code and associated interpretive code to detect special cipher characters and determine a first set of scores. The memory stores computer program instructions that, when executed, cause the processing device to process, by a second set of one or more detectors, the RTE code and the associated interpretive code to detect malware and determine a second set of scores. The memory stores computer program instructions that, when executed, cause the processing device to determine whether one or both of the RTE code and the associated interpretive code are compromised based on the first set of scores and the second set of scores.

Examples of the apparatus include various technical features that yield technical effects that provide various improvements to computer technology. For instance, some examples include the technical features of process, by a first set of one or more detectors, RTE code and associated interpretive code to detect special cipher characters and determine a first set of scores; process, by a second set of one or more detectors, the RTE code and the associated interpretive code to detect malware and determine a second set of scores; and determine whether one or both of the RTE code and the associated interpretive code are compromised based on the first set of scores and the second set of scores. These technical features yield the technical effect of providing information discovery in a high entropy system. By employing multiple analysis techniques and detector systems, obfuscated or encrypted threats that may have previously avoided detection may be discovered and handled accordingly. Some examples provide the ability to predict that an RTE has been compromised and is capable of producing unexpected alternative and likely malicious execution paths that may not be able to be detected by current scanning methods. Some examples identify possible lock and key scenarios that may produce malicious execution behavior.

In some examples of the apparatus, the first set of one or more detectors is to determine a first set of characterizations and scores, the second set of one or more detectors is to determine a second set of characterizations and scores, and where determining whether one or both of the RTE code and the associated interpretive code are compromised is based on the first set of characterizations and scores and the second set of characterizations and scores. These technical features yield the technical effect of employing multiple detectors to determine multiple characterizations and scores to facilitate identification of threats that may have previously avoided detection.

In some examples of the apparatus, the second set of one or more detectors is to detect native malware, and the memory stores computer program instructions that, when executed, cause the processing device to process, by a third set of one or more detectors, the RTE code and the associated interpretive code to detect encoded or encrypted malware and determine a third set of scores; and determine whether one or both of the RTE code and the associated interpretive code are compromised based on the first set of scores, the second set of scores, and the third set of scores. These technical features yield the technical effect of employing multiple detectors to determine multiple scores to facilitate identification of obfuscated or encrypted threats that may have previously avoided detection.

In some examples of the apparatus, the memory stores computer program instructions that, when executed, cause the processing device to convert, by the third set of one or more detectors, the RTE code and the associated interpretive code to data in one or more spectral formats; and analyze the data in the one or more spectral formats.

Another example of the present disclosure is directed to a computer program product including a computer readable storage medium. The computer readable storage medium includes computer program instructions that, when executed, process, by a first set of one or more detectors, RTE code and associated interpretive code to detect special cipher characters and determine a first set of scores. The computer readable storage medium includes computer program instructions that, when executed, process, by a second set of one or more detectors, the RTE code and the associated interpretive code to detect malware and determine a second set of scores. The computer readable storage medium includes computer program instructions that, when executed, determine whether one or both of the RTE code and the associated interpretive code are compromised based on the first set of scores and the second set of scores.

Examples of the computer program product include various technical features that yield technical effects that provide various improvements to computer technology. For instance, some examples include the technical features of process, by a first set of one or more detectors, run time environment (RTE) code and associated interpretive code to detect special cipher characters and determine a first set of scores; process, by a second set of one or more detectors, the RTE code and the associated interpretive code to detect malware and determine a second set of scores; and determine whether one or both of the RTE code and the associated interpretive code are compromised based on the first set of scores and the second set of scores. These technical features yield the technical effect of providing information discovery in a high entropy system. By employing multiple analysis techniques and detector systems, obfuscated or encrypted threats that may have previously avoided detection may be discovered and handled accordingly. Some examples provide the ability to predict that an RTE has been compromised and is capable of producing unexpected alternative and likely malicious execution paths that may not be able to be detected by current scanning methods. Some examples identify possible lock and key scenarios that may produce malicious execution behavior.

In some examples of the computer program product, the first set of one or more detectors is to determine a first set of characterizations and scores, the second set of one or more detectors is to determine a second set of characterizations and scores, and where determining whether one or both of the RTE code and the associated interpretive code are compromised is based on the first set of characterizations and scores and the second set of characterizations and scores. These technical features yield the technical effect of employing multiple detectors to determine multiple characterizations and scores to facilitate identification of threats that may have previously avoided detection.

In some examples of the computer program product, the second set of one or more detectors is to detect native malware, and the computer readable storage medium includes computer program instructions that, when executed, process, by a third set of one or more detectors, the RTE code and the associated interpretive code to detect encoded or encrypted malware and determine a third set of scores, and where determining whether one or both of the RTE code and the associated interpretive code are compromised is based on the first set of scores, the second set of scores, and the third set of scores. These technical features yield the technical effect of employing multiple detectors to determine multiple scores to facilitate identification of obfuscated or encrypted threats that may have previously avoided detection.

Another example of the present disclosure is directed to a method for binary malware attack detection, which includes processing, by a first set of one or more detectors, RTE code and associated interpretive code to detect special cipher characters and determine a first set of scores. The method includes processing, by a second set of one or more detectors, the RTE code and the associated interpretive code to detect native malware and determine a second set of scores. The method includes processing, by a third set of one or more detectors, the RTE code and the associated interpretive code to detect encoded or encrypted malware and determine a third set of scores. The method includes determining whether one or both of the RTE code and the associated interpretive code are compromised based on the first set of scores, the second set of scores, and the third set of scores.

Examples of the method include various technical features that yield technical effects that provide various improvements to computer technology. For instance, some examples include the technical features of processing, by a first set of one or more detectors, RTE code and associated interpretive code to detect special cipher characters and determine a first set of scores; processing, by a second set of one or more detectors, the RTE code and the associated interpretive code to detect native malware and determine a second set of scores; processing, by a third set of one or more detectors, the RTE code and the associated interpretive code to detect encoded or encrypted malware and determine a third set of scores; and determining whether one or both of the RTE code and the associated interpretive code are compromised based on the first set of scores, the second set of scores, and the third set of scores. These technical features yield the technical effect of providing information discovery in a high entropy system. By employing multiple analysis techniques and detector systems, obfuscated or encrypted threats that may have previously avoided detection may be discovered and handled accordingly. Some examples provide the ability to predict that an RTE has been compromised and is capable of producing unexpected alternative and likely malicious execution paths that may not be able to be detected by current scanning methods. Some examples identify possible lock and key scenarios that may produce malicious execution behavior.

In some examples of the method, the first set of one or more detectors is to determine a first set of characterizations and scores, the second set of one or more detectors is to determine a second set of characterizations and scores, the third set of one or more detectors is to determine a third set of characterizations and scores, and where determining whether one or both of the RTE code and the associated interpretive code are compromised is based on the first set of characterizations and scores, the second set of characterizations and scores, and the third set of characterizations and scores. These technical features yield the technical effect of employing multiple detectors to determine multiple characterizations and scores to facilitate identification of threats that may have previously avoided detection.

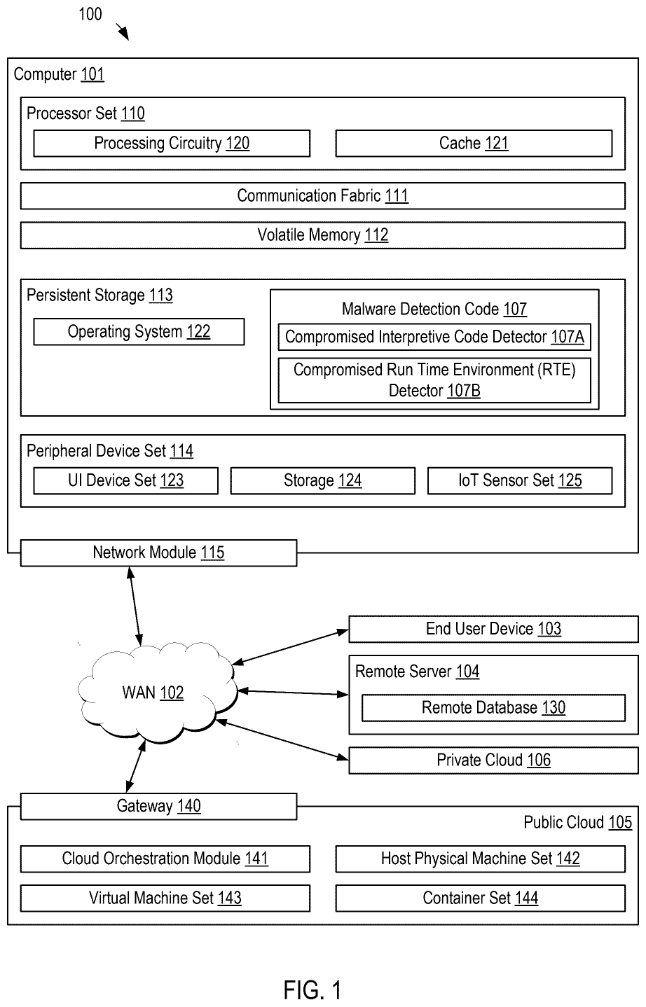

FIG. 1 sets forth an example computing environment 100 according to aspects of the present disclosure. Computing environment 100 contains an example of an environment for the execution of at least some of the computer code involved in performing the various methods described herein, such as malware detection code 107. Malware detection code 107 includes compromised interpretive code detector 107A and compromised RTE detector 107B. In addition to malware detection code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and malware detection code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in malware detection code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in malware detection code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

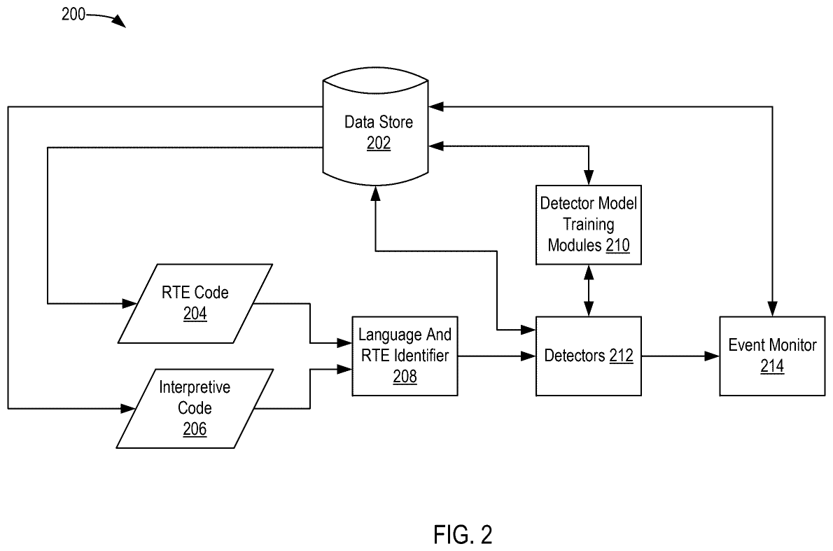

FIG. 2 sets forth an example malware detection system 200 according to aspects of the present disclosure. Malware detection system 200 may implement malware detection code 107 (FIG. 1). Malware detection system 200 includes data store 202, language and RTE identifier 208, detector model training modules 210, detectors 212, and event monitor 214. RTE code 204 and associated interpretive code 206 to be analyzed are retrieved from data store 202 and provided to language and RTE identifier 208. The RTE code 204 may be any one of a variety of different types of RTEs, including a virtual machine (VM), a Java Virtual Machine (JVM), Jupyter Notebook, as well as others. The interpretive code 206 may be any one of a variety of different interpretive programming languages, including Java, Java Script, Python, PHP, Perl, Rexx, Ruby, Power shell, as well as others. Language and RTE identifier 208 identifies an RTE type for the RTE code 204 and an interpretive programming language type for the interpretive code 206. Language and RTE identifier 208 provides the RTE code 204 to selected ones of the detectors in detectors 212 based on the RTE type for the RTE code, and provides the interpretive code 206 to selected ones of the detectors in detectors 212 based on the interpretive programming language type for the interpretive code 206.

One or more detectors in detectors 212 analyze the RTE code 204 and the interpretive code 206 to determine if the RTE code 204 is compromised and/or if the interpretive code 206 is compromised. Some examples disclosed herein are not based upon a single detector but rather an ensemble of detectors for a compromised RTE and/or its accompanying compromised interpretive code that it could be operating against. Each detector in detectors 212 may be focused on a different method of malicious content insertion, including (1) detection of special cipher characters; (2) detection of native malware; and (3) detection of encrypted malware. In some examples, the detectors 212 operate passively, and independently characterize and score its specific results, which are aggregated into a Bayesian normalization model to mitigate bias by any one detector. In some examples, the detectors 212 detect specific patterns, signals and characteristics that are not just anomalous but have strong indicators of malicious content capability warranting additional investigation.

In a supply chain based binary weapon attack, the compromised RTE may act as a lock, and the compromised interpretive code may act as a key for the lock. Use cases for a compromised RTE include: (1) use of special characters to launch a specific payload; (2) use of special characters to launch a specific payload plus employ malware in interpretive code; and (3) use of special characters to launch a specific payload plus employ malware that is decrypted in interpretive code. Use cases for compromised interpretive code include: (1) use of special cipher characters only to trigger compromised RTE specific payloads; (2) use of special cipher characters plus malicious code embedded in native text/comment fields to trigger a compromised RTE specific payload; and (3) use of special characters plus malicious code encrypted/encoded with a key embedded in text/comment fields.

In some examples, detectors 212 take the RTE code 204 and the interpretive code 206 and apply detector specific methods to extract key features as inputs for artificial intelligence (AI) based models. A frequency detector in the detectors 212 may extract frequency, amplitude and phase of opcodes, code strings of known functionality, system calls, API calls or function calls. An image processing detector of detectors 212 may convert files to Gabor features, which also represents specific operands (individually or collectively), code strings of known functionality, system calls, API calls or function calls. An entropy detector of detectors 212 may apply Dyadic Wavelet Transform (DWT) and Shannon entropy calculations to extract entropy transition and value coefficients features for machine and deep learning models. The detectors 212 take the extracted and formatted features and perform a classification and scoring analysis (e.g., benign, malicious, suspicious).

Data store 202 may act as a repository of all data for malware detection system 200. Data store 202 may contain results about benign, malicious, or suspicious samples from other components in the system such as detectors 212. Data store 202 may contain the preferred models for use by the detectors 212. Data store 202 may contain detected malware, and any other information related to detecting ongoing threats to a system under analysis. Data store 202 according to some examples is a persistent storage medium that may be secured against attacks and unauthorized modification of the data.

Detector model training modules 210 may train the detectors 212 prior to operation, or retrain the detectors 212 in real time. For model training, pre-conditioning techniques such as down sampling, filtering, and block size averaging may be employed as the size of the data being analyzed may vary greatly which may impact feature extraction.

Event monitor 214 may receive alerts from other components in the malware detection system 200. These alerts may include detection of malicious and/or suspicious code confirmed by the detectors 212. The contents of the alerts may be logged, conveyed to a user through an interface, or sent to another system for analysis. Event monitor 214 may send an alert to a developer to indicate that code/libraries are potentially compromised, and indicate what was found and where it was found.

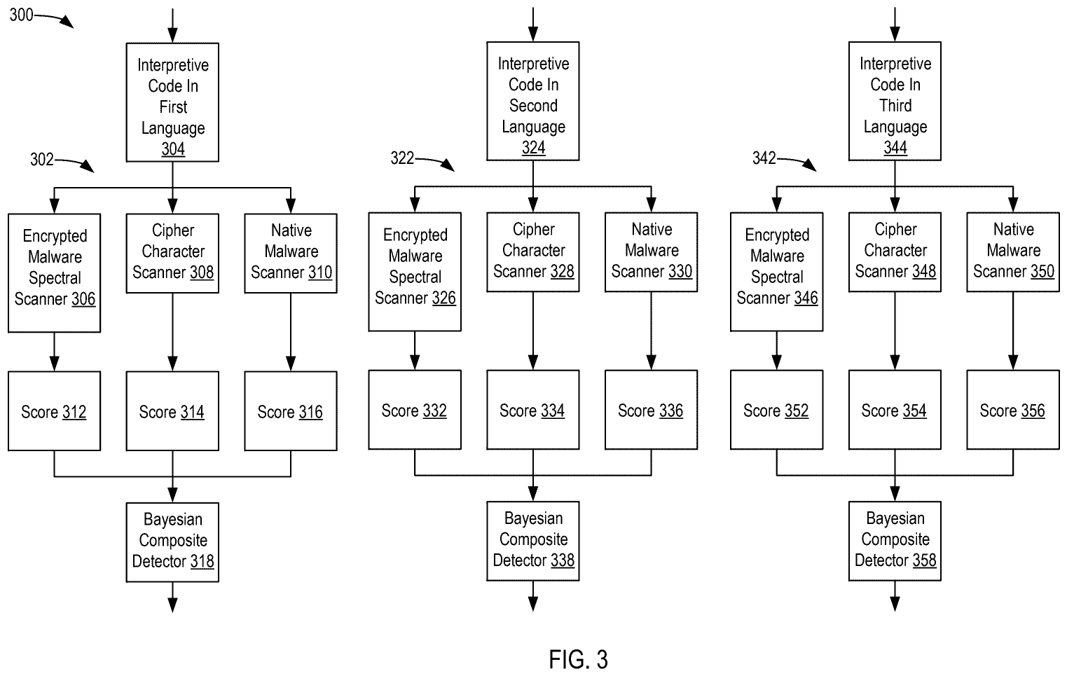

FIG. 3 sets forth a compromised interpretive code detection system 300 according to aspects of the present disclosure. Compromised interpretive code detection system 300 is an example implementation of compromised interpretive code detector 107A (FIG. 1), and may be incorporated into detectors 212 (FIG. 2). Compromised interpretive code detection system 300 includes three sets of detectors 302, 322, and 342 for detecting compromised interpretive code. In other examples, compromised interpretive code detection system 300 may include more or less than three sets of detectors. The first set of detectors 302 is configured to receive and process interpretive code that is in a first interpretive programming language (e.g., Java or Java Script), as indicated by interpretive code in first language 304. The second set of detectors 322 is configured to receive and process interpretive code that is in a second interpretive programming language (e.g., Perl), as indicated by interpretive code in second language 324. The third set of detectors 342 is configured to receive and process interpretive code that is in a third interpretive programming language (e.g., Python), as indicated by interpretive code in third language 344. In some examples, language and RTE identifier 208 (FIG. 2) may provide interpretive code (e.g., interpretive code 304, 324, or 344) to a selected one of the sets of detectors 302, 322, or 342 based on the interpretive programming language type for the interpretive code as determined by the language and RTE identifier 208. In some examples, each of the detectors in the sets of detectors 302, 322, and 342 is a pre-compilation detector that employs an artificial intelligence (e.g., deep learning) detector model.

The first set of detectors 302 includes encrypted malware spectral scanner 306, cipher character scanner 308, native malware scanner 310, and Bayesian composite detector 318. Encrypted malware spectral scanner 306 analyzes the received interpretive code 304 and generates a corresponding score 312 based on the analysis. Cipher character scanner 308 analyzes the received interpretive code 304 and generates a corresponding score 314 based on the analysis. Native malware scanner 310 analyzes the received interpretive code 304 and generates a corresponding score 316 based on the analysis. Bayesian composite detector 318 aggregates the three scores 312, 314, and 316 into a Bayesian normalization model to mitigate bias by any one of the detectors in the set of detectors 302.

The second set of detectors 322 includes encrypted malware spectral scanner 326, cipher character scanner 328, native malware scanner 330, and Bayesian composite detector 338. Encrypted malware spectral scanner 326 analyzes the received interpretive code 324 and generates a corresponding score 332 based on the analysis. Cipher character scanner 328 analyzes the received interpretive code 324 and generates a corresponding score 334 based on the analysis. Native malware scanner 330 analyzes the received interpretive code 324 and generates a corresponding score 336 based on the analysis. Bayesian composite detector 338 aggregates the three scores 332, 334, and 336 into a Bayesian normalization model to mitigate bias by any one of the detectors in the set of detectors 322.

The third set of detectors 342 includes encrypted malware spectral scanner 346, cipher character scanner 348, native malware scanner 350, and Bayesian composite detector 358. Encrypted malware spectral scanner 346 analyzes the received interpretive code 344 and generates a corresponding score 352 based on the analysis. Cipher character scanner 348 analyzes the received interpretive code 344 and generates a corresponding score 354 based on the analysis. Native malware scanner 350 analyzes the received interpretive code 344 and generates a corresponding score 356 based on the analysis. Bayesian composite detector 358 aggregates the three scores 352, 354, and 356 into a Bayesian normalization model to mitigate bias by any one of the detectors in the set of detectors 342.

The first set of detectors 302 will now be described in more detail. In some examples, the second set of detectors 322 and the third set of detectors 342 operate in substantially the same manner as the first set of detectors 302 but are configured to process other interpretive programming languages.

The cipher character scanner 308 scans the interpretive code 304 prior to submission to an RTE to detect and validate that a sequence (e.g., both known and unusual) of special cipher characters representing a trigger portion of a cyber binary weapon is present in the interpretive code 304, indicating that the interpretive code 304 is compromised. Cipher characters can have multiple classes of information content, including: (1) the character itself; (2) cipher characters can be any keys on a standard keyboard or an imported special character or image; (3) the sequence/grouping of characters; (4) the color(s) of characters; (5) the font of characters; (6) style of characters; and (7) any or all of the previous classes combined. Characteristics of interpretive cipher code include: (1) special cipher code can be delimiters as part of comment/text or embedded in run code with no impact to code execution; (2) malicious interpretive code will only execute in a compromised RTE; and (3) text/comment fields can contain additional malicious code (e.g., either encrypted/encoded or native) to compliment compromised RTE code.

The native malware scanner 310 scans the interpretive code 304 (e.g., both executable as well as non-executable text/comments) prior to submission to an RTE to detect whether non-encrypted malware is embedded in the interpretive code 304. In some examples, the native malware scanner 310 employs scanning techniques via patterns, heuristics, and/or sequences.

The encrypted malware spectral scanner 306 scans the interpretive code 304 prior to submission to an RTE to detect whether encrypted and/or encoded malware is embedded in the interpretive code 304. In some examples, the encrypted malware spectral scanner 306 employs an ensemble of spectral analysis deep learning techniques. Detection of low observable signals designed to exhibit unpredictable and rare occurrences below background noise or employ signal masking-encryption techniques has been a major challenge. On one hand, these techniques are employed to protect classified/sensitive information or mask behavior as part of a deception campaign, while on the other hand, the ability to detect and extract meaningful information from an adversary is the key to avoiding strategic surprise and reshaping behavior to one's advantage.

Encryption techniques such as Advanced Encryption Standard (AES), Rivest, Shamir, and Adleman (RSA), Elliptic Curve Cryptography (ECC), etc. employing secret keys, public keys, hash functions and one-time pads are the standard bearers. These cryptographic algorithms if used and protected properly, are designed to scramble information/signal to such an extent that any attempts to employ massive amounts of classical computing power to decrypt them may currently be futile.

Encryption of information is not just to protect sensitive messages but may also be employed on malware designed to defeat anti-virus (AV) from detection. These AV solutions may employ a combination of heuristics and signature analysis with some early application of machine and deep learning techniques but may not be effective in detection and classification of encrypted malware. In essence, the key information necessary to characterize and detect malware has been so obfuscated by encryption that it appears in the spectral domain to resemble “white noise”.

In some examples, encrypted malware spectral scanner 326 employs deep spectral analysis to extract highly obfuscated information in a high entropy environment. Information features or attributes used by encrypted malware spectral scanner 326 fall into three categories: dependent, independent, and invariant variables. In some examples, encrypted malware spectral scanner 326 performs characterization and detection-tracking of the invariant features, which retain information through transformation decorrelation tiers.

Information to be analyzed by encrypted malware spectral scanner 326 may include foreground features (e.g., edges), which are invariant features, and background features (e.g., color and textures). As entropy is increased via encoding/encryption, background features decorrelate into noise with edges being the last feature to decorrelate. There are multi-dimensional features on at least two planes (foreground and background). Foreground analysis has edges in the case of images, and these are the more resilient features in the face of entropy. In the frequency domain, the same phenomena is experienced for background features, including amplitude, power spectrum, and phase. For foreground features, the frequency is subject to a red/blue shift.

In some examples, encrypted malware spectral scanner 326 applies multiple spectral analysis approaches (e.g., image, acoustic, and entropy) to detect and characterize a signal. Techniques described herein are effective against the native file format, and when a file is converted to Base64 encoding. In addition, when a file is encrypted using AES-256 CBC, enough “signal” remains for detection and classification. Some observations include: (1) Code appears to have a frequency range between 400 hz and 1.5 Khz; (2) Base64 encoding caused code to redshift down in frequency and added a noise figure, but frequency grouping remained correlated; (3) For AES-256 encryption, a similar transformation was observed with higher decorrelation of frequency bins, but information-signal still was observable despite looking in the time domain as white noise; and (4) different system calls, code strings, API calls, and function calls all exhibited different frequency signatures that can be characterized.

In some examples, encrypted malware spectral scanner 326 performs an image analysis, which may also be called computer vision. In some examples, encrypted malware spectral scanner 326 also performs a frequency analysis technique common to audio and radio frequency analysis, which involves a Fast Fourier Transform (FFT). Both the image analysis and frequency analysis techniques involve generating features used to tune models for machine learning. Benign and surrogate malicious files may be analyzed using an image analysis technique and a frequency analysis technique. Both techniques may be used to analyze the benign code to generate features and train models for machine analysis. Those trained models may then be used to analyze the surrogate malicious files. The trained models may be optimized against the surrogate malicious files.

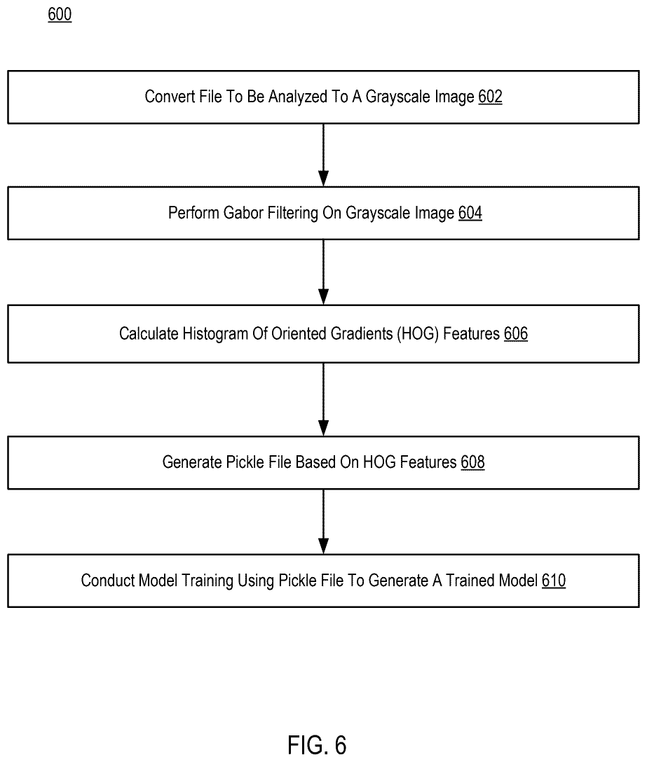

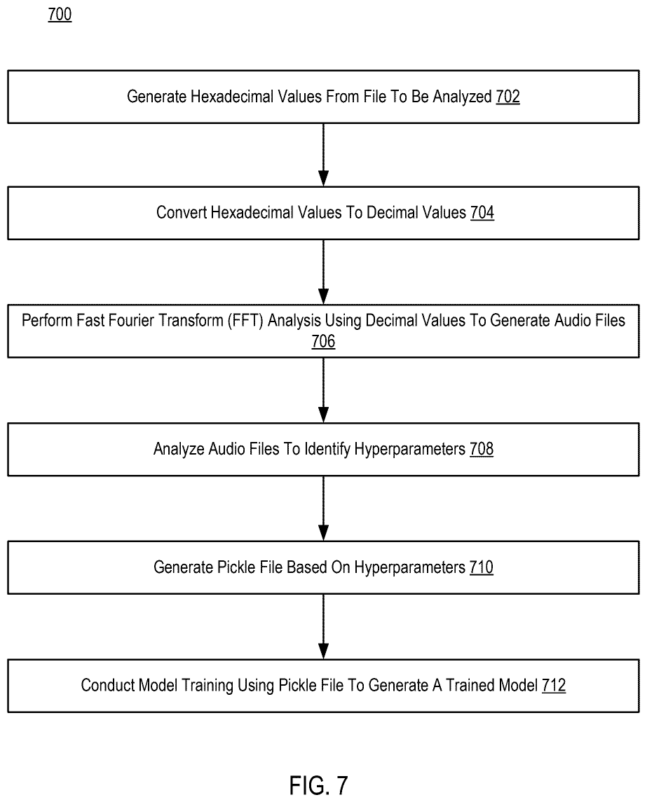

In some examples, encrypted malware spectral scanner 326 may convert received files into spectral formats. In an example, the three spectral formats may include: acoustic (frequency), infrared (heat maps for entropy), and visual (image processing). In some examples, encrypted malware spectral scanner 326 analyzes data spectrally. Encrypted malware spectral scanner 326 is able to classify obfuscated, packed and/or encrypted code designed to evade classical analysis techniques. Spectral analysis is utilized to uncover subtle, low observable anomalies in code that is inconsistent with normal environmental attributes and behavior. Encrypted malware spectral scanner 326 extracts information from a high entropy environment. Examples of the image analysis technique and the frequency analysis technique are described in further detail below with reference to FIGS. 6 and 7.

The Bayesian composite detector 318 receives the scores 312, 314, and 316 and determines a final classification. In some examples, the final classification may be one of three classes (e.g., benign, malicious, and suspicious). In other examples, the final classification may be one of two classes (e.g., benign and compromised). In yet other examples, other classifications and other numbers of classifications may be used. Benign results may be dropped, and suspicious/malicious/compromised results may be stored in the data store 202 (FIG. 2). Suspicious/malicious/compromised results may be sent to event monitor 214 (FIG. 2) to send out an alert to the system administrator or other user.

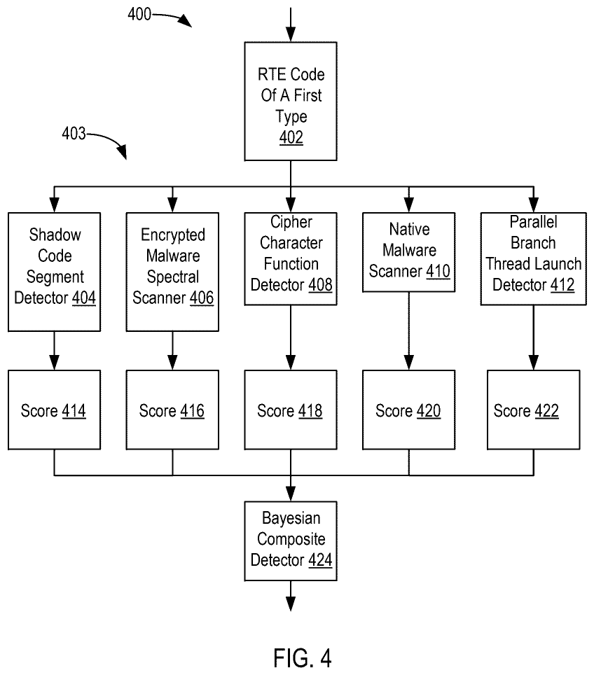

FIG. 4 sets forth a compromised RTE detection system 400 according to aspects of the present disclosure. Compromised RTE detection system 400 is an example implementation of compromised RTE detector 107B (FIG. 1), and may be incorporated into detectors 212 (FIG. 2). Compromised RTE detection system 400 includes a set of detectors 403 for detecting a compromised RTE. The set of detectors 403 is configured to receive and process RTE code of a first type 402 (e.g., VM, JVM, or Jupyter Notebook). In some examples, compromised RTE detection system 400 may include additional sets of detectors to process RTEs of additional RTE types. In some examples, language and RTE identifier 208 (FIG. 2) may provide RTE code of a first type 402 to the set of detectors 403 based on the RTE type determined by the language and RTE identifier 208. In some examples, each of the detectors in the set of detectors 403 employs an artificial intelligence (e.g., deep learning) detector model, and the set of detectors 403 may employ a similar set of deep learning models as those employed for the sets of detectors 302, 322, and 342 (FIG. 3).

The set of detectors 403 includes shadow code segment detector 404, encrypted malware spectral scanner 406, cipher character function detector 408, native malware scanner 410, parallel branch thread launch detector 412, and Bayesian composite detector 424. Shadow code segment detector 404 analyzes the received RTE code 402 and generates a corresponding score 414 based on the analysis. Encrypted malware spectral scanner 406 analyzes the received RTE code 402 and generates a corresponding score 416 based on the analysis. Cipher character function detector 408 analyzes the received RTE code 402 and generates a corresponding score 418 based on the analysis. Native malware scanner 410 analyzes the received RTE code 402 and generates a corresponding score 420 based on the analysis. Parallel branch thread launch detector 412 analyzes the received RTE code 402 and generates a corresponding score 422 based on the analysis. Bayesian composite detector 424 aggregates the five scores 414, 416, 418, 420, and 422 into a Bayesian normalization model to mitigate bias by any one of the detectors in the set of detectors 403.

The cipher character function detector 408 scans the RTE code 402 every time a new version of the RTE has been updated as part of the development environment (e.g., upgrade) to help ensure detection of a supply chain based attack. The cipher character function detector 408 detects whether cipher character functions are included in the RTE code 402. The native malware scanner 410 scans the RTE code 402 every time a new version of the RTE has been updated to detect whether non-encrypted malware is embedded in the RTE code 402. The encrypted malware spectral scanner 406 scans the RTE code 402 every time a new version of the RTE has been updated to detect whether encrypted and/or encoded malware is embedded in the RTE code 402. In some examples, the encrypted malware spectral scanner 306 employs an ensemble of spectral analysis deep learning techniques. The shadow code segment detector 404 scans the RTE code 402 every time a new version of the RTE has been updated to detect whether any shadow code segments are included in the RTE code 402. The parallel branch thread launch detector 412 scans the RTE code 402 every time a new version of the RTE has been updated to detect whether any parallel branch thread launch code segments are included in the RTE code 402.

The Bayesian composite detector 424 receives the scores 414, 416, 418, 420, and 422, and determines a final classification. In some examples, the final classification may be one of three classes (e.g., benign, malicious, and suspicious). In other examples, the final classification may be one of two classes (e.g., benign and compromised). In yet other examples, other classifications and other numbers of classifications may be used. Benign results may be dropped, and suspicious/malicious/compromised results may be stored in the data store 202 (FIG. 2). Suspicious/malicious/compromised results may be sent to event monitor 214 (FIG. 2) to send out an alert to the system administrator or other user.

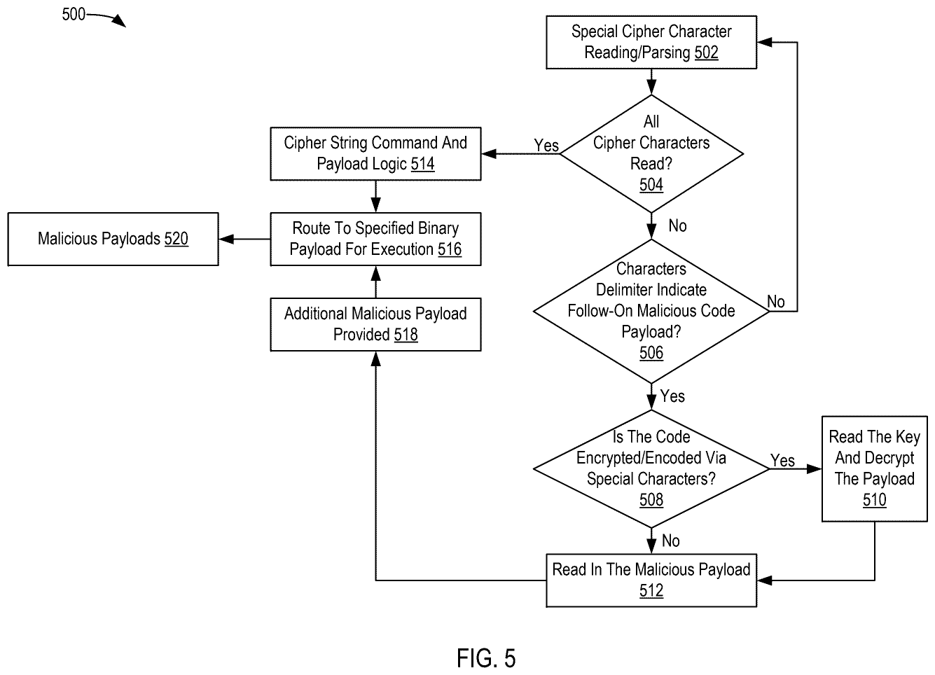

FIG. 5 sets forth a flow diagram of a method 500 for compromised RTE detection according to aspects of the present disclosure. In a particular embodiment, the method 500 may be performed by compromised RTE detection system 400 (FIG. 4), and may be performed utilizing malware detection code 107 (FIG. 1). In some examples, method 500 detects a compromised RTE that may include malicious code. Compromised RTE characteristics may include: (1) compromised as supply chain attack(s) during update; (2) can be one or more RTEs compromised; (3) can be time delayed based on run time logic; (4) can be specific victim/target oriented based on logic; (5) malicious payloads can be encrypted/encoded and made operational only at run time; (6) no impact to non-malicious code, will fork/branch and execute both; (7) modify log files to remove any traces of parallel execution; and (8) malicious payload may always be targeted to memory.

Method 500 includes reading/parsing 502 special cipher characters in the RTE code being analyzed. At 504, it is determined whether all cipher characters in the RTE code have been read. If it is determined at 504 that all cipher characters have been read, the method 500 moves to 514. At 514, a cipher string command and payload logic are determined from the cipher characters. At 516, the system routes to a specified binary payload for execution, which is indicated by malicious payloads 520.

If it is determined at 504 that all cipher characters have not been read, the method 500 moves to 506. At 506, it is determined whether a characters delimiter indicates follow-on malicious code payload. If it is determined at 506 that the characters delimiter does not indicate follow-on malicious code payload, the method 500 returns to 502 to continue reading/parsing remaining special cipher characters. If it is determined at 506 that the characters delimiter indicates follow-on malicious code payload, the method 500 moves to 508. At 508, it is determined whether the code is encrypted/encoded via special characters. If it is determined at 508 that the code is not encrypted/encoded, the method 500 moves to 512. If it is determined at 508 that the code is encrypted/encoded, the method 500 moves to 510. At 510, the system reads the key and decrypts the payload. At 512, the system reads in the malicious payload, and the method 500 moves to 518. At 518, the additional malicious payload is provided, and the method 500 moves to 516. The additional malicious payload is sent to accompany the cipher string command for routing and execution by the specific malicious payload. At 516, the system routes to a specified binary payload for execution, which is indicated by malicious payloads 520.

FIG. 6 sets forth a flow diagram of a malware detection method 600 using image analysis according to aspects of the present disclosure. In a particular embodiment, the method 600 may be performed by encrypted malware spectral scanner 326 (FIG. 3), and may be performed utilizing malware detection code 107 (FIG. 1). Method 600 includes converting 602 a file to be analyzed to a grayscale image. In some examples, a DLL.text section binary file may be converted to an 8-bit grayscale image at 602 in method 600. In some examples, each pixel of the grayscale image is eight bits (0, 255), with 0=black and 255=white.

Method 600 includes performing 604 Gabor filtering on the grayscale image. In some examples, Gabor filters are applied to create filter banks. The Gabor filtering may be used for texture analysis to identify frequency content and directionality (texture). Hyperparameters to use with Gabor texture filtering for feature extraction include Ksize, aspect, orientation, phase, wavelength, and bandwidth (BW). Grayscale texture (texture primitive=intensity (gray level), regular/repeated pattern, orientation, edge transition, co-occurrence (similar gray tones), intensity per region) may indicate: (1) code transition type (abrupt, smooth, rough-coarse); (2) code string specific (ripple); (3) code obfuscation; (4) opcodes, function and API calls with arguments; (5) code transformation (base64, AES); and (6) segmentation/boundary. Texture types include spots, ripples, edges, intensity transitions (light to dark, dark to light), and solid-continuous pattern intensity.

Method 600 includes calculating 606 a histogram of oriented gradients (HOG) features. In some examples, the results of the filtering at 604 are used at 606 to calculate HOG features such as gradient computation, orientation binning, descriptor blocks, and block normalization. Method 600 includes generating 608 a pickle file based on the HOG features. Method 600 includes conducting 610 model training using the pickle file to generate a trained model. In some examples, the HOG features generated at 606 are fed into a python-based analysis process via the pickle file to conduct the model training. In some examples, generating the trained model at 610 is an iterative process to determine which is the nominal feature-model combination that achieves acceptable performance goals. In some examples, the model is trained at 610 for binary classification. In some examples, generating the trained model at 610 includes computing accuracy, precision, recall, and F1 scores. Models with different feature types may be tested to determine the most optimal feature map for classification. Some examples may use one or more of the following statistical models for image analysis: Support Vector Machine (SVM), Random Forest, CNN-Conv2D, as well as other models.

FIG. 7 sets forth a flow diagram of a malware detection method 700 using frequency analysis according to aspects of the present disclosure. In a particular embodiment, the method 700 may be performed by encrypted malware spectral scanner 326 (FIG. 3), and may be performed utilizing malware detection code 107 (FIG. 1). Method 700 includes generating 702 hexadecimal values from the file to be analyzed. In some examples, each set of two bytes of data in the file to be analyzed is combined into a double byte hexadecimal value. Method 700 includes converting 704 the hexadecimal values to decimal values. Each decimal value is a sample point for an FFT analysis. In some examples of the frequency analysis in method 700, the test data is in the same format as that of the image Gabor in the image analysis in method 600, with the following exceptions: (1) For Gabor, each pixel is 8 bits or one byte; (2) for frequency analysis, 2 bytes are used for each sample point of the FFT; and (3) for frequency analysis, a labeled class is bracketed with the respective DLL code front and back.

Method 700 includes performing 706 an FFT analysis using the decimal values to generate audio files. When a DLL file, for example, is visualized as an audio file, the sections of pseudo malicious code may be visible as audio sections bracketed by benign code from the DLL file. The portion of malicious code will have a pulse width with a start and a finish, and within the pulse is a frequency dispersion that characterizes the malware and is unique as compared to the bracketing benign code before and after the malware. Method 700 includes analyzing 708 the audio files to identify hyperparameters. Hyperparameters that may be used to experiment with FFT for feature extraction include: (1) window length; (2) sample rate; (3) step size; and (4) number of FFT samples.

Method 700 includes generating 710 a pickle file based on the hyperparameters. Method 700 includes conducting 712 model training using the pickle file to generate a trained model. Thus, in some examples, analysis of the audio files yields hyperparameters, which are fed via a pickle file into a model training process. In some examples, generating the trained model at 712 is an iterative process to determine which is the nominal feature-model combination that achieves acceptable performance goals. In some examples, the model is trained at 712 for binary classification. In some examples, generating the trained model at 712 includes computing accuracy, precision, recall, and F1 scores. Models with different feature types may be tested to determine the most optimal feature map for classification. Some examples may use one or more of the following statistical models for frequency analysis: Support Vector Machine (SVM), Random Forest, RNN-LSTM, as well as other models.

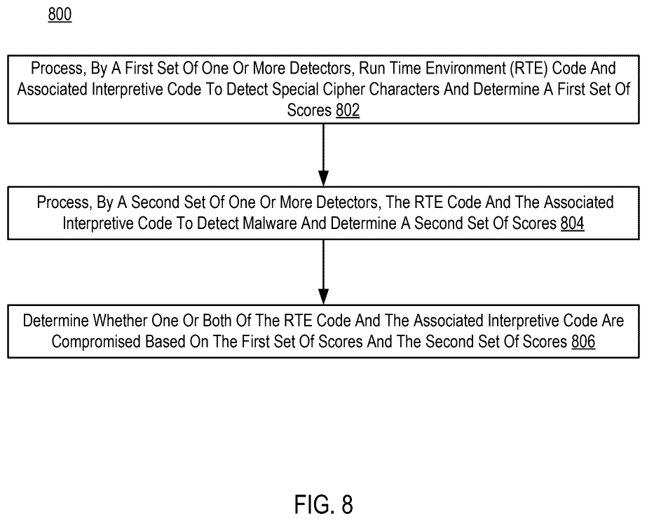

FIG. 8 sets forth a flow diagram of a method 800 for binary malware attack detection according to aspects of the present disclosure. In a particular embodiment, the method 800 may be performed by malware detection system (FIG. 2), and may be performed utilizing malware detection code 107 (FIG. 1). Method 800 includes processing 802, by a first set of one or more detectors, run time environment (RTE) code and associated interpretive code to detect special cipher characters and determine a first set of scores. Method 800 includes processing 804, by a second set of one or more detectors, the RTE code and the associated interpretive code to detect malware and determine a second set of scores. Method 800 includes determining 806 whether one or both of the RTE code and the associated interpretive code are compromised based on the first set of scores and the second set of scores.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for binary malware attack detection comprising:
processing, by a first set of one or more detectors, run time environment (RTE) code and associated interpretive code to detect special cipher characters and determine a first set of scores;
processing, by a second set of one or more detectors, the RTE code and the associated interpretive code to detect malware and determine a second set of scores; and
determining whether one or both of the RTE code and the associated interpretive code are compromised based on the first set of scores and the second set of scores.

2. The method of claim 1, wherein the first set of one or more detectors is to determine a first set of characterizations and scores, wherein the second set of one or more detectors is to determine a second set of characterizations and scores, and wherein determining whether one or both of the RTE code and the associated interpretive code are compromised is based on the first set of characterizations and scores and the second set of characterizations and scores.

3. The method of claim 1, wherein the second set of one or more detectors is to detect native malware, and wherein the method further comprises:
processing, by a third set of one or more detectors, the RTE code and the associated interpretive code to detect encoded or encrypted malware and determine a third set of scores; and
determining whether one or both of the RTE code and the associated interpretive code are compromised based on the first set of scores, the second set of scores, and the third set of scores.

4. The method of claim 3, wherein processing, by the third set of one or more detectors, the RTE code and the associated interpretive code, comprises:
converting the RTE code and the associated interpretive code to data in one or more spectral formats; and
analyzing the data in the one or more spectral formats.

5. The method of claim 4, wherein the one or more spectral formats includes an acoustic format.

6. The method of claim 4, wherein the one or more spectral formats includes an image format.

7. The method of claim 4, wherein the third set of one or more detectors includes one or more machine learning models trained using known malware.

8. The method of claim 1, and further comprising:
generating, in response to determining that one or both of the RTE code and the associated interpretive code are compromised, an alert.

9. A system for binary malware attack detection comprising:
a first set of one or more detectors to process run time environment (RTE) code and associated interpretive code to detect special cipher characters and determine a first set of scores;
a second set of one or more detectors to process the RTE code and the associated interpretive code to detect malware and determine a second set of scores; and
a composite detector to determine whether one or both of the RTE code and the associated interpretive code are compromised based on the first set of scores and the second set of scores.

10. The system of claim 9, wherein the first set of one or more detectors is to determine a first set of characterizations and scores, wherein the second set of one or more detectors is to determine a second set of characterizations and scores, and wherein the composite detector is to determine whether one or both of the RTE code and the associated interpretive code are compromised based on the first set of characterizations and scores and the second set of characterizations and scores.

11. The system of claim 9, wherein the second set of one or more detectors is to detect native malware, and wherein the system further comprises:
a third set of one or more detectors to process the RTE code and the associated interpretive code to detect encoded or encrypted malware and determine a third set of scores, and wherein the composite detector is to determine whether one or both of the RTE code and the associated interpretive code are compromised based on the first set of scores, the second set of scores, and the third set of scores.

12. The system of claim 11, wherein the third set of one or more detectors are to convert the RTE code and the associated interpretive code to data in one or more spectral formats, and analyze the data in the one or more spectral formats.

13. The system of claim 12, wherein the one or more spectral formats includes an acoustic format.

14. The system of claim 12, wherein the one or more spectral formats includes an image format.

15. The system of claim 12, wherein the third set of one or more detectors includes one or more machine learning models trained using known malware.

16. The system of claim 9, and further comprising:
an alert monitor to generate, in response to determining that one or both of the RTE code and the associated interpretive code are compromised, an alert.

17. An apparatus for binary malware attack detection comprising:
a processing device; and
memory operatively coupled to the processing device, wherein the memory stores computer program instructions that, when executed, cause the processing device to:
process, by a first set of one or more detectors, run time environment (RTE) code and associated interpretive code to detect special cipher characters and determine a first set of scores;
process, by a second set of one or more detectors, the RTE code and the associated interpretive code to detect malware and determine a second set of scores; and
determine whether one or both of the RTE code and the associated interpretive code are compromised based on the first set of scores and the second set of scores.

18. The apparatus of claim 17, wherein the first set of one or more detectors is to determine a first set of characterizations and scores, wherein the second set of one or more detectors is to determine a second set of characterizations and scores, and wherein determining whether one or both of the RTE code and the associated interpretive code are compromised is based on the first set of characterizations and scores and the second set of characterizations and scores.

19. The apparatus of claim 17, wherein the second set of one or more detectors is to detect native malware, and wherein the memory stores computer program instructions that, when executed, cause the processing device to:
process, by a third set of one or more detectors, the RTE code and the associated interpretive code to detect encoded or encrypted malware and determine a third set of scores; and
determine whether one or both of the RTE code and the associated interpretive code are compromised based on the first set of scores, the second set of scores, and the third set of scores.

20. The apparatus of claim 19, wherein the memory stores computer program instructions that, when executed, cause the processing device to:
convert, by the third set of one or more detectors, the RTE code and the associated interpretive code to data in one or more spectral formats; and
analyze the data in the one or more spectral formats.

21. A computer program product comprising a computer readable storage medium, wherein the computer readable storage medium comprises computer program instructions that, when executed:
process, by a first set of one or more detectors, run time environment (RTE) code and associated interpretive code to detect special cipher characters and determine a first set of scores;
process, by a second set of one or more detectors, the RTE code and the associated interpretive code to detect malware and determine a second set of scores; and
determine whether one or both of the RTE code and the associated interpretive code are compromised based on the first set of scores and the second set of scores.

22. The computer program product of claim 21, wherein the first set of one or more detectors is to determine a first set of characterizations and scores, wherein the second set of one or more detectors is to determine a second set of characterizations and scores, and wherein determining whether one or both of the RTE code and the associated interpretive code are compromised is based on the first set of characterizations and scores and the second set of characterizations and scores.

23. The computer program product of claim 21, wherein the second set of one or more detectors is to detect native malware, and wherein the computer readable storage medium comprises computer program instructions that, when executed:
process, by a third set of one or more detectors, the RTE code and the associated interpretive code to detect encoded or encrypted malware and determine a third set of scores, and wherein determining whether one or both of the RTE code and the associated interpretive code are compromised is based on the first set of scores, the second set of scores, and the third set of scores.

24. A method for binary malware attack detection comprising:
processing, by a first set of one or more detectors, run time environment (RTE) code and associated interpretive code to detect special cipher characters and determine a first set of scores;
processing, by a second set of one or more detectors, the RTE code and the associated interpretive code to detect native malware and determine a second set of scores;
processing, by a third set of one or more detectors, the RTE code and the associated interpretive code to detect encoded or encrypted malware and determine a third set of scores; and
determining whether one or both of the RTE code and the associated interpretive code are compromised based on the first set of scores, the second set of scores, and the third set of scores.

25. The method of claim 24, wherein the first set of one or more detectors is to determine a first set of characterizations and scores, wherein the second set of one or more detectors is to determine a second set of characterizations and scores, wherein the third set of one or more detectors is to determine a third set of characterizations and scores, and wherein determining whether one or both of the RTE code and the associated interpretive code are compromised is based on the first set of characterizations and scores, the second set of characterizations and scores, and the third set of characterizations and scores.
